(19) United States
(12) Patent Application Publication
(10) Pub. No.: US 2014/0337427 A1
(43) Pub. Date: Nov. 13, 2014

(54) SYSTEM FOR RECOMMENDING ELECTRONIC CONTENTS

(71) Applicant: DeNA Co., Ltd., Tokyo (JP)

(72) Inventors: Koichi HAMADA, Tokyo (JP); Toshiharu KUROKI, Tokyo (JP); Takahide KIMURA, Tokyo (JP); Katsura KIRIYAMA, Tokyo (JP)

(73) Assignee: DeNA Co., Ltd., Tokyo (JP)

(21) Appl. No.: 13/962,801

(22) Filed: Aug. 8, 2013

(30) Foreign Application Priority Data
May 7, 2013 (JP) 2013-097946

(51) Int. Cl. H04L 29/06

(52) U.S. Cl. CPC H04L 29/06
USPC 709/204

(57) ABSTRACT

A system according to an embodiment recommends, to users, electronic contents which can be enjoyed together with other users. The system includes: a service provision control unit for controlling provision of services; an information storage unit for storing information; a selection unit for selecting, from a plurality of games, recommended games to be recommended to a user and selecting, from a plurality of users, one or more introduction users to be introduced to the user as users using the recommended games; a screen setting unit for setting the screen data of a content recommendation screen; a sending unit for sending the screen data of the content recommendation screen to the terminal device; and a reward providing unit for providing a reward to the user or the introduction users.

### CROSS-REFERENCE TO RELATED APPLICATIONS

This application is based on and claims the benefit of priority from Japanese Patent Application Serial No. 2013-097946 (filed on May 7, 2013), the contents of which are hereby incorporated by reference in their entirety.

### TECHNICAL FIELD

The present invention relates to a system and a method of recommending electronic contents by using the system, and in particular, to a system capable of providing a plurality of electronic contents to a plurality of users operating terminal devices communicatively connected to the system and a method of recommending electronic contents by using the system.

### BACKGROUND

Conventionally proposed such systems include a system aimed at recommending contents that fit preferences of individual users (see, e.g., Japanese Patent Application Publication No. 2008-191768). In this system, recommendation information on contents is exchanged between users in a SNS-based network group formed in accordance with preferences of users, such that the users can obtain recommendation information on contents that fit their own preferences.

### SUMMARY

However, in such a system, contents are recommended based only on information exchanged between the users; and the users may not be aware of having a common preference in other contents. Accordingly, users not aware of having a common preference in contents, such as online games which a plurality of users can enjoy together, may miss chances to enjoy the contents together. Further, it is unknown to what degree a user who recommends a content actually uses the content therefore, when a user who received a recommendation starts using the content, hoping to enjoy the content together with the user who recommended it, he may be disappointed if the user who recommended the content actually does not use it so much and fails to enjoy it together. Accordingly, it is desired that contents which a plurality of users can actually enjoy together are recommended so as to activate communication between users.

One object of the embodiments of the present invention is to recommend, to a user, electronic contents which can be enjoyed together with other users. Other objects of the present invention will be clarified by reference to the entire description in this specification.

The system according to an embodiment of the present invention is a system capable of providing a plurality of electronic contents to a plurality of users each operating a terminal device communicatively connected to the system, the system comprising: an information storage unit configured to store at least closeness information specifying closeness between the plurality of users and use degree information specifying degree of use of each of the plurality of electronic contents by each of the plurality of users; and one or more processors capable of executing a program, wherein the program comprises: a selection module configured to select, from the plurality of electronic contents, a recommended electronic content to be recommended to one user and select, from the plurality of users, one or more other users to be introduced as users using the recommended electronic content based on the closeness information and the use degree information; a screen setting module configured to set screen data of a content recommendation screen including information specifying the recommended electronic content to be recommended to the one user and information specifying the one or more other users to be introduced; and a sending module configured to send the screen data to the terminal device operated by the one user. The “closeness” refers to the degree of closeness and includes any mode of information indicating the degree of closeness in two or more levels. For example, the closeness includes information indicative of whether users are “close” or “not close.” The “degree of use” refers to the degree of use and includes any mode of information indicating the degree of use in two or more levels. For example, the degree of use includes information indicative of whether a user “uses” or “does not use” an electronic content. Further, “a recommended electronic content to be recommended to a user” includes both the mode where electronic contents yet to be used by the user are recommended and the mode where electronic contents already used by the user are recommended. Additionally, “electronic contents” include online games, electronic books, video contents, and music contents, etc.

The system according to an embodiment of the present invention is a system capable of providing a plurality of electronic contents to a plurality of users each operating a terminal device communicatively connected to the system, the system comprising: an information storage means for storing at least closeness information specifying closeness between the plurality of users and use degree information specifying degree of use of each of the plurality of electronic contents by each of the plurality of users; and a selection means for selecting, from the plurality of electronic contents, a recommended electronic content to be recommended to one user and selecting, from the plurality of users, one or more other users to be introduced as users using the recommended electronic content based on the closeness information and the use degree information; a screen setting means for setting screen data of a content recommendation screen including information specifying the recommended electronic content to be recommended to the one user and information specifying the one or more other users to be introduced; and a sending means for sending the screen data to the terminal device operated by the one user.

The method of recommending an electronic content according to an embodiment of the present invention is a method of recommending electronic contents by using a system capable of providing a plurality of electronic contents to a plurality of users each operating a terminal device communicatively connected to the system, the method comprising the steps of: (a) storing, on the system, at least closeness information specifying closeness between the plurality of users and use degree information specifying degree of use of each of the plurality of electronic contents by each of the plurality of users; (b) selecting, from the plurality of electronic contents, a recommended electronic content to be recommended to one user and selecting, from the plurality of users, one or more other users to be introduced as users using the recommended electronic content based on the closeness information and the use degree information; (c) setting screen data of a content recommendation screen including information specifying the recommended electronic content to be recommended to the one user and information specifying the one or more other users to be introduced; and (d) sending the screen data to the terminal device operated by the one user.

Various embodiments of the present invention enables recommending, to a user, electronic contents which can be enjoyed together with other users.

### BRIEF DESCRIPTION OF THE DRAWINGS

FIG. 1 is a block diagram schematically illustrating a network configuration of a system according to an embodiment of the present invention.

FIG. 2 is a block diagram schematically illustrating the architecture of a terminal device according to an embodiment.

FIG. 3 is a block diagram illustrating the functionality of the system according to an embodiment.

FIG. 4 is a diagram showing an example of information managed by a user-to-user relationship management table according to an embodiment.

FIG. 5 is a diagram showing an example of information managed by a communication management table according to an embodiment.

FIG. 6 is a diagram showing an example of information managed by a content use management table according to an embodiment.

FIG. 7 is a diagram showing an example of information managed by a recommended content management table according to an embodiment.

FIG. 8 is a flow diagram showing an example of a selection process according to an embodiment.

FIG. 9 is a flow diagram showing an example of a screen setting/display process according to an embodiment.

FIG. 10 is a diagram showing an example of My Page screen according to an embodiment.

FIG. 11 is a diagram showing an example of My Game screen according to an embodiment.

FIG. 12 is a diagram showing an example of Friend List screen according to an embodiment.

### DESCRIPTION OF EXAMPLE EMBODIMENTS

Various embodiments of the present invention will be described hereinafter with reference to the drawings. In the drawings, the same components are denoted by the same reference numerals.

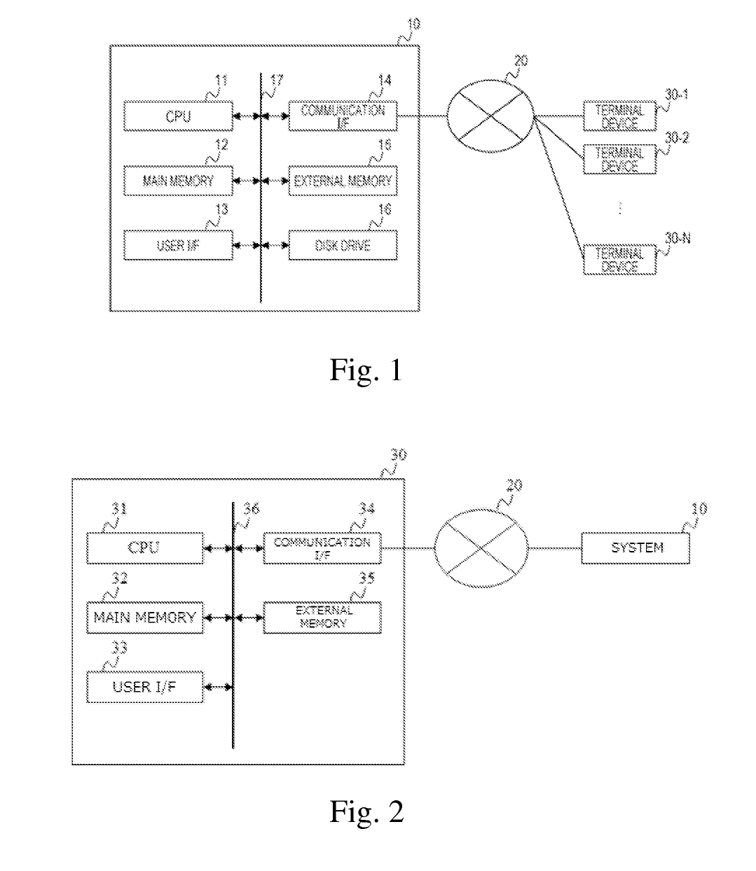

FIG. 1 is a block diagram schematically illustrating a network configuration including a system 10 according to an embodiment of the present invention. As illustrated in FIG. 1, the system 10 according to an embodiment may be communicatively connected to a plurality of terminal devices 30-1, 30-2, . . . , and 30-N (hereinafter also collectively referred to as the “terminal devices 30”), each having a communication function, via a communication network 20 such as the Internet. The server device 10 may serve as a platform for providing users operating the terminal devices 30 with various electronic contents including online games, electronic books, video contents, and music contents and various services such as SNS and call/message exchange.

As illustrated in FIG. 1, the system 10 according to an embodiment may include a central processing unit (CPU) (processor) 11, a main memory 12, a user interface (I/F) 13, a communication I/F 14, an external memory 15, and a disk drive 16, and these components may be electrically connected to one another via a bus 17. The CPU 11 may load an operating system and various programs into the main memory 12 from the external memory 15, and may execute commands included in the loaded programs. The main memory 12 may be used to store a program to be executed by the CPU 11, and may be formed of, for example, a dynamic random access memory (DRAM).

The user I/F 13 may include, for example, an information input device such as a keyboard or a mouse for accepting an input from an operator, and an information output device such as a liquid crystal display for outputting calculation results of the CPU 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the terminal devices 30 via the communication network 20.

The external memory 15 may be formed of, for example, a magnetic disk drive and store a control program for controlling provision of various services such as games. The external memory 15 may also store various data used in the various services. The various data that may be stored in the external memory 15 may also be stored on a database server communicatively connected to the system 10 and physically separate from the system 10. The disk drive 16 may read data stored in a storage medium such as a compact disc read only memory (CD-ROM), digital versatile disc read only memory (DVD-ROM), or DVD Recordable (DVD-R) disc, or writes data to such a storage medium. For example, applications stored in a storage medium and data for use in the various services may be read by the disk drive 16, and may be installed into the external memory 15.

In an embodiment, the system 10 may be a web server for managing a web site including a plurality of hierarchical web pages and may be capable of providing the terminal devices 30 with various services such as various games, SNS, music distribution, and call/message exchange. The terminal devices 30 may fetch HTML data for rendering a web page from the system 10 and analyze the fetched HTML data to present the web page to a user of the terminal devices 30. A game provided through such a web page is sometimes called a browser game. The HTML data for rendering the web page may also be stored on the external memory 15. HTML data may comprise HTML documents written in markup languages such as HTML; the HTML documents may be associated with various images. Additionally, the HTML documents may include programs written in script languages such as ActionScript™ and JavaScript™.

The external memory 15 may store applications to be executed on execution environments of the terminal device 30 other than browser software. These applications may include programs for receiving services and various data such as image data to be referred to for executing the programs. The programs may be created in, for example, object oriented languages such as Objective-C™ and Java™. The created programs may be stored on the external memory 15 in the form of application software along with various data. The application software stored on the external memory 15 may be delivered to a terminal device 30 in response to a delivery request. The application software delivered from the system 10 may be received by the terminal device 30 through a communication I/F 34 in accordance with the control of CPU 31; the received programs may be sent to an external memory 35 and stored thereon. The application software may be launched in accordance with the user's operation on the terminal device 30 and may be executed on an execution environment implemented on the terminal device 30 such as NgCore™ or Android™. The system 10 may provide the applications executed on the terminal devices 30 with various data required for providing services. Additionally, the system 10 can store various data sent from the terminal device 30 for each user, thereby managing the state of provided services (e.g., the progression of the game) for each user.

Thus, the system 10 may manage the web site for providing various services and deliver web pages constituting the web site in response to a request from the terminal device 30, thereby providing a service to a user. Also, the system 10 can provide services based on communication with an application performed on the terminal device 30 in place of, or in addition to, such browser-based services. Whichever mode may be taken to provide the services, the system 10 can store data required to provide the services for each identification identifying a user. Briefly, the system 10 may also include a function to authenticate a user at start of provision of services and perform charging process in accordance with provision of services. The games provided by the system 10 may include desired games such as action games, role playing games, interactive baseball games, and card games. The types of the games implemented by the system 10 are not limited to those explicitly disclosed herein.

In an embodiment, the terminal device 30 may be any information processing device that may display on a web browser a web page of a web site for providing services obtained from the system 10 and include an executing environment for executing applications.

The architecture of the terminal device 30 will be described with reference to FIG. 2. FIG. 2 is a block diagram schematically illustrating the architecture of a terminal device 30. As illustrated in FIG. 2, the terminal device 30 may include a central processing unit (CPU) 31, a main memory 32, a user interface (I/F) 33, a communication I/F 34, and an external memory 35, and these components may be electrically connected to one another via a bus 36.

The CPU 31 may load various programs such as an operating system into the main memory 32 from the external memory 35, and may execute commands included in the loaded programs. The main memory 32 may be used to store a program to be executed by the CPU 31, and may be formed of, for example, a dynamic random access memory (DRAM).

The user I/F 33 may include, for example, an information input device such as a touch panel, a keyboard, a button, and a mouse for accepting an input from a user, and an information output device such as a liquid crystal display for outputting calculation results of the CPU 31. The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the system 10 via the communication network 20.

The external memory 35 may comprise, for example, a magnetic disk drive or a flash memory and store various programs such as an operating system. When receiving an application from a system 10 via the communication I/F 34, the external memory 35 may store the received application.

A terminal device 30 having such an architecture may include, for example, browser software for interpreting an HTML file (HTML data) and rendering a screen; this browser software may enable the terminal device 30 to interpret the HTML data fetched from the system 10 and render web pages corresponding to the received HTML data. Further, the terminal device 30 may include plug-in software (e.g., Flash Player distributed by Adobe Systems Incorporated) embedded into browser software; therefore, the terminal device 30 can fetch from the system 10 a SWF file embedded in HTML data and execute the SWF file by using the browser software and the plug-in software.

When a service is received on the terminal device 30, for example, animation or an operation icon designated by the program may be displayed on a screen of the terminal device 30. The user may enter an instruction for receiving the service using an input interface of the terminal device 30. The instruction entered by the user may be transmitted to the system 10 through the browser of the terminal device 30 or a function of an execution environment such as NgCore™.

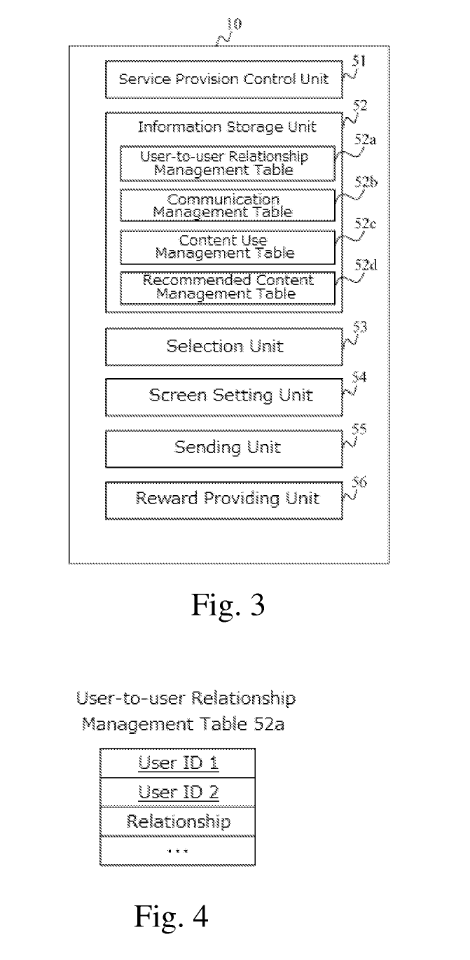

Next, the functionality of the system 10 implemented by the components shown in FIG. 1 will now be described. As described above, the system 10, which can provide various services including provision of electronic contents, will now be described with a focus on functions related to online games as electronic contents. Online games are examples suitable for description of an embodiment of the present invention. FIG. 3 is a block diagram illustrating the functionality of a system 10 according to an embodiment of the present invention. As shown, the system 10 may include: a service provision control unit 51 for controlling provision of services such as progression of games; an information storage unit 52 for storing information; a selection unit 53 for selecting, from a plurality of games, recommended games to be recommended to a user and selecting, from a plurality of users, one or more introduction users (other users) to be introduced to the user as users using the recommended games, based on closeness between a plurality of users and degree of use of each game (electronic content) by each user; a screen setting unit 54 for setting the screen data of a content recommendation screen including information specifying the recommended games and information specifying the introduction users; a sending unit 55 for sending the screen data of the content recommendation screen to the terminal device 30 operated by the corresponding user; and a reward providing unit 56 for providing a reward to a user or an introduction user, the user selecting a link to a content-related screen or a link to a user-related screen included in the content recommendation screen. These functions may be implemented through cooperation between the CPU 11 of the system 10 and various programs and tables stored in the main memory 12 and the external memory 15, wherein, for example, the CPU 11, a processor, performs a program including at least part of modules corresponding to the functions of the service provision control unit 51, selection unit 53, screen setting unit 54, sending unit 55, and reward providing unit 56.

The service provision control unit 51 may send and receive various data required for providing services such as the progression of various games to and from the terminal device 30 and manage such data for each user, thereby controlling provision of the services for each user. For example, the service provision control unit 51 can sequentially display, on the terminal device 30, web pages constituting a web site for providing services in response to a request from the terminal device 30. When a hyperlink on the displayed web page is selected by the user, the service provision control unit 51 may send new HTML data corresponding to the hyperlink to the terminal device 30. The terminal device 30 may display a web page based on the new HTML data. Thus, the service provision control unit 51 may control the service such that web pages stored on the system 10 are sequentially provided to the terminal device 30 in accordance with the operation by the user; and the user can receive the service, or progress the game for example, by his own operation through the function of the service provision control unit 51.

When the terminal device 30 executes the game application, the service provision control unit 51 can send various data used in the game to the game application. For example, when receiving from a game application on the terminal device 30 a control signal indicating that a certain mission has been cleared, the service provision control unit 51 may provide the game application with various parameters related to a mission subsequent to the cleared mission. The game application may load the data provided by the system 10 and progress the game.

The terminal device 30 can appropriately send to the system 10 various information on progression of the game such as information indicating various parameter values used in the game (information on earned game points and earned items) and information indicating a status (information specifying a fulfilled mission), through the function of browser software or the game application. The service provision control unit 51 may store, for each user, information on the progression of the game received from a plurality of terminal devices 30, thereby controlling the progression of the game for each user. Thus, when the user logs in the system 10 using his own ID, the game may be resumed from the stage corresponding to the progression of the user (e.g., the stage where the game was interrupted) based on the information on the progression of the game associated with the user and stored in the system 10. The information required for the progression of the game may also be managed by various functions of the system 10 other than the service provision control unit 51.

The information storage unit 52 may include a user-to-user relationship management table 52a for managing information on relationship between users (user-to-user relationship information), a communication management table 52b for managing information on communication between users (communication information), a content use management table 52c for managing information on use of each game (electronic content) by each user, and a recommended content management table 52d for managing information on games recommended to users. FIG. 4 shows an example of information managed by the user-to-user relationship management table 52a. As shown, the user-to-user relationship management table 52a may manage information such as “relationship” representing the relationship between two users identified by the two user IDs (“user ID 1” and “user ID 2”). The values of the “relationship” in an embodiment may include “friend,” a relationship formed when a user approves a friend application from another user, and “circle company,” a relationship between users included in a same circle. The circle is one of SNS services provided by the system 10 wherein users mutually exchange information on a subject via a message board, etc. Further, in an embodiment, “friend” may be of various types, such as a friend of a type corresponding to an object service (e.g., a friend in game A, a friend in musical content providing services, or a fiend in a platform). In an embodiment, friends and circle companies may be managed by the user-to-user relationship management table 52a; however, other tables may also be used to manage these information. As to “circle company” for example, a table for managing information on users may manage circles including the users; and based on this information, users included in a same circle may be specified.

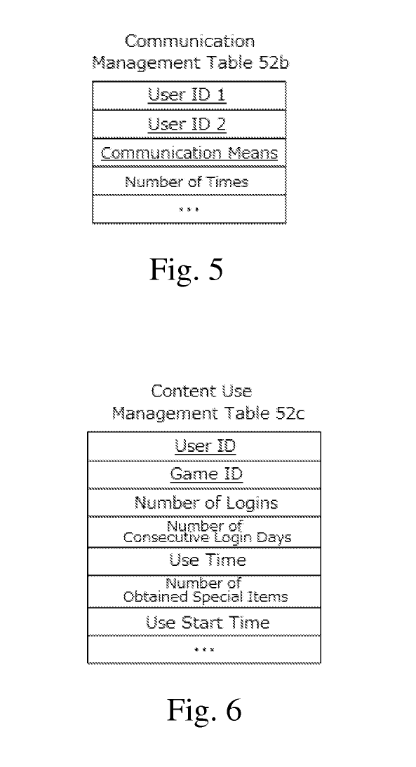

FIG. 5 shows an example of information managed by the communication management table 52b. As shown, the communication management table 52b may include two user IDs (“user ID 1” and “user ID 2”) and means (a service or function) for communication between users provided by the system 10 (“communication means”), and also manage, in association with combinations of these items, information such as “number of times” indicating the number of times of communication between the users using the communication means. The values of “communication means” in an embodiment may include “call,” “message exchange,” “chat,” “greeting,” and “display.” The value “display” may refer to display of a user on another user's screen for receiving various services provided by the system 10; for example, a user is displayed on a screen used for an online game as a top level ranker of the game, as a candidate for an opponent in a battle, or as a candidate for a company to perform a cooperation play. Additionally, when the value of the “communication means” is “display” “number of times” contains the number of times of display of the user identified by “user ID 2” on the screen used by the user identified by “user ID 1” (that is, the degree of communication in which the user of the user ID 1 sees the user of the user ID 2 on the screen). When the “communication means” is “call” or “chat” for example, “time” indicating the total time of communication may also be managed in place of, or in addition to, “number of times.” Further, the values of the “communication means” may also include an action in a specific game (electronic content) such as “a battle in game D.” In an embodiment, the information in the communication management table 52b may be updated by the service provision control unit 51 for each communication described above.

FIG. 6 shows an example of information managed by the content use management table 52c. As shown, the content use management table 52c may include “user ID” for identifying a user and “game ID” for identifying a game, and also manage, in association with combinations of these items, “number of logins” indicating the number of times when this user logged in this game, “number of consecutive login days” indicating the number of consecutive days when this user logged in this game, “use time” indicating the total use time of this game, “number of obtained special items” indicating the number of special items obtained in this game, and “use start time” indicating the date and time when use of this game was started. Additionally, the content use management table 52c may also manage information on games yet to be used (in this case, “number of logins,” “number of consecutive login days,” “use time,” “number of obtained special items,” and “use start time” may be blank).

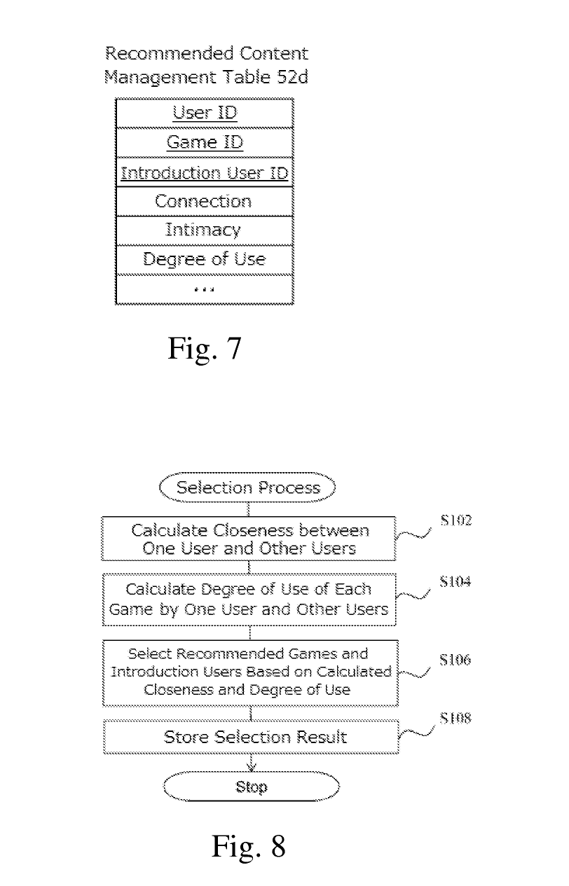

FIG. 7 shows an example of information managed by the recommended content management table 52d. As shown, the recommended content management table 52d may include “user ID” for identifying a user, “game ID” for identifying a game, and “introduction user ID” identifying an introduction user to be introduced as a user using this game, and also manage, in association with combinations of these items, “connection” indicating the connection between the user and the introduction user, “closeness” indicating the closeness between the user and the introduction user, and “degree of use” indicating the degree of use of the game by the introduction user. These information may be set by the selection unit 53 based on the information managed by the user-to-user relationship management table 52a, the communication management table 52b, and the content use management table 52c. These information will be further descried later.

Next, operations of such a system 10 as an embodiment of the present invention will now be described. The description will be first focused on operations related to selection of recommended games and introduction users to be introduced as users using the recommended games, and then on operations related to setting and display of a content recommendation screen including information on the recommended games and the introduction users. FIG. 8 is a flow diagram showing an example of a selection process performed by the system 10 (selection unit 53). The selection process in an embodiment may be performed regularly (e.g., at one-hour intervals, or at 11 a.m. every day) in accordance with a predetermined schedule.

As shown, the first step of the selection process is to calculate closeness between users (step S102). In an embodiment, the closeness may be calculated based on information stored in the user-to-user relationship management table 52a and the communication management table 52b. The calculation may be performed by various methods. For example, the closeness may be calculated to be higher with the number of “relationships” between users (managed in the user-to-user relationship management table 52a) or with the number of times of communication between users (managed in the communication management table 52b). If the number of times of communication between users is used to calculate the closeness, the closeness between one user and another user may also be calculated to be higher with the proportion of the number of times of communication with the other user among the total number of times of communication by the one user (that is, with the occupancy among the total number of times of communication). It may also be possible that, for example, weighting is applied to calculation of the closeness in accordance with “relationship” between the users (e.g., weighting is applied such that “friend” impacts calculation of the closeness more than “circle company”), or weighting is applied to calculation of the closeness in accordance with “communication means” of communication between users (e.g., weighting is applied such that “greeting” impacts calculation of the closeness more than “display”). Further, the calculated closeness may be in various forms, such as a number (e.g., 0 to 100 points), a rank (e.g., five level ranks represented by A to E), or a Boolean value indicating whether the users are “close” or “not close.”

Next, the degree of use of each game is calculated for each user (step S104). In an embodiment, the degree of use may be calculated based on information managed by the content use management table 52c. The calculation may be performed by various methods. For example, the degree of use may be calculated to be higher with “number of logins,” “number of consecutive login days,” “use time,” and “number of obtained special items.” It may also be possible that, for example, weighting is applied to the values of “number of logins,” “number of consecutive login days,” “use time,” and “number of obtained special items” (e.g., weighting may be applied such that “use time” impacts the calculation of the degree of use more than “number of logins”). Further, as with the closeness described above, the calculated degree of use may be in various forms, such as a number (e.g., 0 to 100 points), a rank (e.g., five level ranks represented by A to E), or a Boolean value indicating whether the users “use” or “not use” the game.

After calculating the closeness between users and the degree of use by each user, the system 10 may select recommended games to be recommended to each user and introduction users to be introduced as other users using the recommended games, based on the calculated closeness and degree of use (step S106). In an embodiment, recommended games and introduction users may be selected by various methods. For example, recommended games may be selected such that games used by other users (e.g., games used by other users at a degree of use higher than a predetermined threshold value), the other users having higher closeness with the one user (to which the recommended games are to be recommended), may be preferentially selected, or such that games used by a larger number of other users (or a larger number of other users having closeness with the one user higher than a predetermined threshold value) may be preferentially selected, or such that games used by other users at a higher degree of use may be preferentially selected. Also, for example, introduction users may be selected such that other users having higher closeness with the one user may be preferentially selected, or such that other users using the selected recommended games at a higher degree of use may be preferentially selected. The number of recommended games selected for one user may be any desirable number and is not limited. Additionally, the number of introduction users selected for one recommended game may be any desirable number and is not limited.

The result of selection of recommended games and introduction users may be stored (step S108), and the selection process may be ended. More specifically, the recommended content management table 52d may store the “user ID” of the one user, the “game ID” of the game selected as a recommended game for the user, the user ID of the user selected as an introduction user for the recommended game (“introduction user ID”), the “connection” between the user and the introduction user, the “closeness” between the user and the introduction user, and the “degree of use” of the recommended game by the introduction user. The “connection” may be one of information items on the introduction user to be displayed on the content recommendation screen (described later), and may be set, in an embodiment, based on information managed by the user-to-user relationship management table 52a and the communication management table 52b. This information will be further descried later.

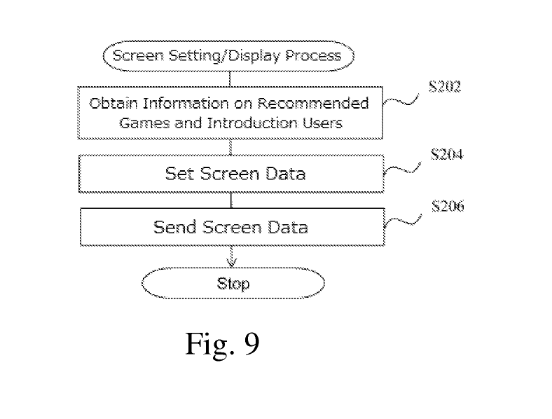

The above was the description of operation concerning how to select recommended games and introduction users to be introduced as users of the recommended games. Next, operation of setting and display of the content recommendation screen containing information on the recommended games and the introduction users will now be described. FIG. 9 is a flow diagram showing an example of a screen setting/display process performed by the system 10 (screen setting unit 54 and sending unit 55). The screen setting/display process may be performed when a display request for the content recommendation screen is received from a terminal device 30. In an embodiment, the content recommendation screen may include various screens provided by the system 10 that may contain information on recommended games and introduction users, such as My Page screen from which users start using various services provided by the system 10, My Game screen from which users start playing various games, and Friend List screen for displaying a list of other users with which the user have a relationship of friends.

As shown, the first step of the screen setting/display process may be to obtain, from the recommended content management table 52d, information on recommended games and introduction users for the user operating the terminal device 30 that made the display request for the content recommendation screen (step S202). More specifically, the system 10 may search the recommended content management table 52d with the “user ID” of the user operating the terminal device 30 and obtain information such as the “game ID,” “introduction user ID,” “connection,” “closeness,” and “degree of use” stored in the retrieved record.

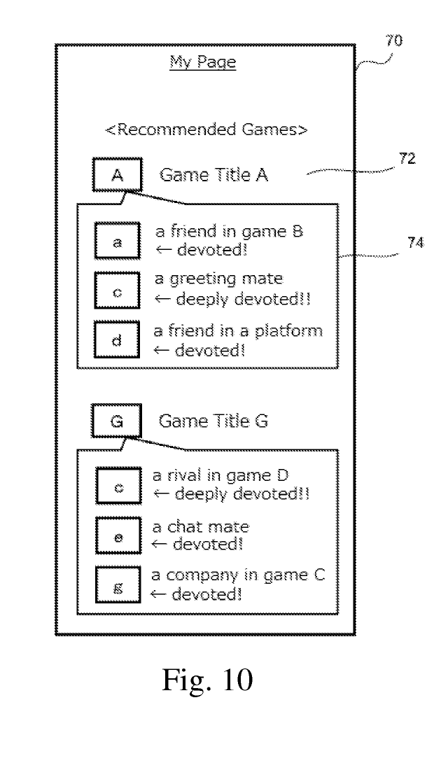

The next step may be to set the screen data of the content recommendation screen based on the retrieved information (step S204), send the set screen data to the terminal device 30 (step S206), and end the screen setting/display process. FIG. 10 is a diagram showing an example of My Page screen 70 as a content recommendation screen displayed on the terminal device 30 that has received the screen data sent in step S206. As described above, My Page screen 70 may be a screen from which the user may start using various services; in the example shown in FIG. 10, recommended games for the user are displayed in a list of “recommended games.” As shown, My Page screen 70 may contain, for each recommended game, a recommended game information display area 72 for displaying information on a recommended game and an introduction user information display area 74 positioned therebelow for displaying information on introduction users for the recommended game. In an embodiment, the recommended game information display area 72 may include an image corresponding to the recommended game in the left, and the name (game title) of the recommended game in the right. In an embodiment, the introduction user information display area 74 may contain information on three introduction users, wherein, for each of the introduction users, the left portion may display an image corresponding to the introduction user (e.g., an avatar image), the upper right portion may display information on the connection between the user operating the terminal device 30 and the introduction user (the example in FIG. 10 displays “a friend in game B,” “a greeting mate,” “a friend in a platform,” “a rival in game D,” “a chat mate,” and “a company in game C”), and the lower right portion may display information on the degree of use of the recommended game by the introduction user (the example in FIG. 10 displays “←devoted!” and “←deeply devoted!!”). Further, the number of recommended games displayed in a list on My Page screen 70 and the number of introduction users displayed for one recommended game may be any desirable numbers and are not limited.

The information on the connection with the introduction user displayed on the introduction user information display area 74 may be information obtained from the column “connection” in the recommended content management table 52d. Of the information on connections shown in FIG. 10, the connections “a friend in game B,” “a friend in a platform,” and “a company in game C” may be information which is managed as “relationship” by the user-to-user relationship management table 52a and then has been stored in the column “connection” of the recommended content management table 52d in the selection process illustrated in FIG. 8. Further, of the information on connections shown in FIG. 10, the connections “a greeting mate,” “a rival in game D,” and “a chat mate” may be information which has likewise been set and registered in the selection process based on information managed by the communication management table 52b. That is, for example, a user may be stored as “a greeting mate” if the number of “greetings” stored in the communication management table 52b is greater than a predetermined threshold value; the user may be stored as “a chat mate” if the number of “chats” is greater than a predetermined threshold value; and the user may be stored as “a rival in game D” if the number of “battles in game D” is greater than a predetermined threshold value. Additionally, if a plurality of connections are possible candidates for the connection with the introduction user, one of them may be selected by a predetermined rule. For example, if there are a plurality of “relationships” with the introduction user, a relationship may be selected in accordance with a predetermined priority order (e.g., “friend” precedes “circle company”); if there are a plurality of possible connections based on information stored in the communication management table 52b, a connection may be selected in accordance with a predetermined priority order (e.g., “chat mate” precedes “greeting mate”); or a “relationship” stored in the user-to-user relationship management table 52a may be selected prior to a connection based on the information stored in the communication management table 52b.

The information on the degree of use by the introduction user displayed in the introduction user information display area 74 may be based on information obtained from the column “degree of use” in the recommended content management table 52d. That is, for example, if the degree of use by the introduction user is greater than a first threshold value and equal to or less than a second threshold value, the displayed information may be “←devoted!”; and if the degree of use is greater than the second threshold value, the displayed information may be “←deeply devoted!!.” The introduction user information display area 74 may contain information on the degree of use by the introduction user in various modes, not only in the above mode. For example, the possible modes are as follows: the value of degree of use may be displayed; the image of the introduction user may be displayed differently (e.g., in different colors and sizes) in accordance with the degree of use; or the information on the connection with the introduction user may be displayed differently (e.g., in different colors and sizes) in accordance with the degree of use. Further, the introduction user information display area 74 may contain information on closeness between the user operating the terminal device 30 and the introduction user in various modes. For example, the possible modes are as follows: the value of closeness may be displayed; the image of the introduction user may be displayed differently (e.g., in different colors and sizes) in accordance with the closeness; the information on the degree of use by the introduction user may be displayed differently (e.g., in different colors and sizes) in accordance with the closeness; or the information on the connection for the introduction user may be displayed differently (e.g., in different colors and sizes) in accordance with the closeness.

At least one of the image and name of the recommended game contained in the recommended game information display area 72 of My Page screen 70 may be provided with a link to a content-related screen related to the recommended game. The content-related screen may be any of various screens related to the recommended game (including various screens such as a screen for using the recommended game and a screen for introducing the recommended game); and, for example, the content-related screen may be used as a top screen from which to start the recommended game. Likewise, at least one of the image of the introduction user, the information on connection with the introduction user, and the information on the degree of use by the introduction user in the introduction user information display area 74 of My Page screen 70 may be provided with a link to a user-related screen related to the introduction user. The user-related screen may be any of various screens related to the introduction user (including various screens such as a screen for displaying various information on the introduction user and a screen for performing various communication with the introduction user); and, for example, the user-related screen may be used as a profile screen of the introduction user in the platform. Further, the user-related screen may be dynamically changed; for example, if there is no relationship of “friend” between the user operating the terminal device 30 and the introduction user, the provided link may link to a screen for making a friend request to the introduction user; and if there is already a relationship of “friend,” the provided link may link to the above described profile screen of the introduction user.

If the recommended game is provided with a profile screen for the game, in addition to the profile screen of the platform, the provided link may link to the profile screen for the game; if the recommended game is not provided with a profile screen for the game, the provided link may link to the profile screen of the platform.

Further, in an embodiment, when the user operating the terminal device 30 selects the link to the content-related screen or the user-related screen, a predetermined reward (e.g., virtual currency usable in the platform provided by the system 10, or a game content usable in the recommended game such as a card or an item) may be provided to the user operating the terminal device 30 and the introduction user. More specifically, when receiving from the terminal device 30 a signal indicating that the above link has been selected, the reward providing unit 56 of the system 10 may provide a reward to the user operating the terminal device 30 and the introduction user and record the provided reward on a table in the information storage unit 52 for managing user information, the table not shown in the figures. Such a reward may also be provided to only one of the user operating the terminal device 30 and the introduction user.

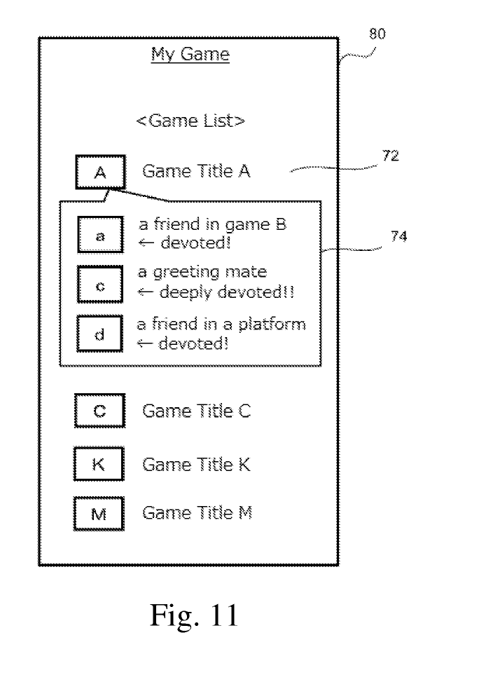

My Page screen 70 shown in FIG. 10 may display recommended games in a list titled “recommended games” that may only include games yet to be used by the user operating the terminal device 30 and may not include games already used by the user operating the terminal device 30. Meanwhile, My Game screen 80 shown in FIG. 11, serving as a content recommendation screen, may display games already used by the user operating the terminal device 30; like My Page screen 70 shown in FIG. 10, this screen may display a recommended game information display area 72 and an introduction user information display area 74 for each of the games already used by the user that are registered in the recommended content management table 52d as recommended games (game title A in the example shown in FIG. 11). Thus, My Game screen 80 may display information on the introduction user using the game already used by the user operating the terminal device 30; this may enable recommendation of games that the user can enjoy with the introduction user. In this case, the link provided to the image and name of a recommended game in the recommended game information display area 72 may link to different screens (content-related screens) depending on the degree of use of the recommended game by the user operating the terminal device 30. For example, if the degree of use by the user exceeds a predetermined threshold value, the link may link to a screen for a special event of the game; and if the degree of use by the user does not exceed a predetermined threshold value, the link may link to a normal top screen. Further, the recommended game information display area 72 may contain information on the degree of use of the recommended game by the user operating the terminal device 30 in various modes. For example, the value of the degree of use may be displayed; or the image and name of the recommended game may be displayed differently (e.g., in different colors and sizes) in accordance with the degree of use. Additionally, the degree of use of the recommended game by the user may be managed by the recommended content management table 52d.

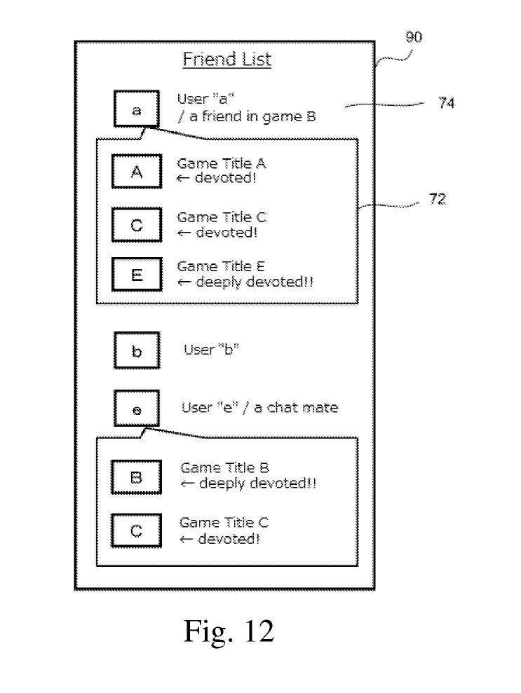

FIG. 12 is a diagram showing an example of a Friend List screen 90 as a content recommendation screen. As shown, Friend List screen 90 may display a list of users in a relationship of “friend” with the user operating the terminal device 30 (managed by the user-to-user relationship management table 52a). As in My Page screen 70 shown in FIG. 10 and My Game screen 80 shown in FIG. 11, the recommended game information display area 72 and the introduction user information display area 74 may be displayed for each of the users displayed in the list and registered in the recommended content management table 52d as introduction users for the recommended game to the user operating the terminal device 30 (that is, user “a” and user “e” in the example shown in FIG. 12). If there are a plurality of recommended games for which a user is registered as an introduction user, the recommended game information display area 72 may display a list of information on the plurality of recommended games. Thus, Friend List screen 90 may display a list of users along with information on recommended games and introduction users; this may enable recommendation (notification) of games that the user can enjoy with the users displayed in the list.

In the embodiment, the selection process shown in FIG. 8 may be performed at regular intervals in accordance with a predetermined schedule; but the time of performing the selection process is not limited thereto. For example, the selection process may be performed upon start of the screen setting/display process as shown in FIG. 9; and each time a display request for the content recommendation screen is received, the system 10 may select the recommended games and the introduction users for the user operating the terminal device 30 that has made the display request for the content recommendation screen.

As described above, the system 10 according to an embodiment of the present invention may select, from a plurality of games, games to be recommended to one user based on closeness between a plurality of users and the degree of use of each of the games (electronic contents) by the users and select, from the plurality of users, other users to be introduced as users using the recommended games; and the system 10 may set screen data of the content recommendation screen including information that specifies the games to be recommended to the one user and information that specifies other users to be introduced and send this screen data to the terminal device operated by the one user. Accordingly, the terminal device may display the content recommendation screen including information on the recommended games and introduction users selected based on closeness and the degree of use; and the user can obtain information on the games used by users close with him. This enables recommending, to the user, games (electronic contents) which can be enjoyed together with other users. Further, the content recommendation screen may contain links to screens related to the recommended games and screens related to the introduction users; therefore, the user can feel free to start using the recommended games and communicating with the introduction users. As a result, the users are encouraged to communicate with each other actively.

The system 10 according to the embodiment was described for the case of recommending online games for example; and the present invention may also be applied to recommendation of other electronic contents such as electronic books, video contents, and music contents. In this case, the content use management table 52c may manage information on use of contents in accordance with the types of the electronic contents.

The processes and procedures described and illustrated herein may be implemented by software, hardware, or any combination thereof other than those explicitly stated for the embodiments. More specifically, the processes and procedures described and illustrated herein may be implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be dispersed and stored in a plurality of memories included in a single apparatus or in a plurality of memories dispersed and arranged in a plurality of apparatuses. The elements of the software and the hardware described herein can be integrated into fewer constituent elements or can be decomposed into more constituent elements.

With respect to the use of substantially any plural and/or singular terms herein, those having skill in the art can translate from the plural to the singular and/or from the singular to the plural as is appropriate to the context.

1. A system capable of providing a plurality of electronic contents to a plurality of users each operating a terminal device communicatively connected to the system, the system comprising:
an information storage unit configured to store at least closeness information specifying closeness between the plurality of users and use degree information specifying degree of use of each of the plurality of electronic contents by each of the plurality of users; and
one or more processors capable of executing a program,
wherein the program comprises:
a selection module configured to select, from the plurality of electronic contents, a recommended electronic content to be recommended to one user and select, from the plurality of users, one or more other users to be introduced as users using the recommended electronic content based on the closeness information and the use degree information;
a screen setting module configured to set screen data of a content recommendation screen including information specifying the recommended electronic content to be recommended to the one user, information specifying the one or more other users to be introduced, and a link to a user-related screen for making a friend request to the one or more other users to be introduced; and
a sending module configured to send the screen data to the terminal device operated by the one user,
wherein the content recommendation screen includes information specifying one or more electronic contents used by the one user and is a screen for the one user to start using the one or more electronic contents, and
wherein the screen setting module sets screen data of the content recommendation screen including information specifying the one or more other users to be introduced and the link to the user-related screen with respect to the recommended electronic content to be recommended to the one user among the one or more electronic contents used by the one user.

2. The system of claim 1, wherein the content recommendation screen further includes a link to a content-related screen related to the recommended electronic content.

3. The system of claim 2, wherein the screen setting module sets the link to the content-related screen as being linked to a screen selected from a plurality of screens related to the recommended electronic content, the selection being based on the degree of use of the recommended electronic content by the one user.

4. (canceled)

5. The system of claim 2, wherein the program further comprises a reward providing module configured to provide a reward to the one user and/or the one or more other users to be introduced when the one user selects the link to the content-related screen and/or the link to the user-related screen included in the content recommendation screen.

6. The system of claim 1 wherein the closeness information includes user-to-user relationship information indicating a relationship between users and communication information specifying a degree of communication between the users.

7. The system of claim 1, wherein the content recommendation screen further includes information on the closeness between the one user and the one or more other users to be introduced.

8. The system of claim 1, wherein the content recommendation screen further includes information on a degree of use of the recommended electronic content by the one or more other users to be introduced.

9. The system of claim 1, wherein the content recommendation screen further includes information on a degree of use of the recommended electronic content by the one user.

10. The system of claim 1, wherein the selection module selects, from the plurality of users, the one or more other users to be introduced such that users having higher closeness with the one user are preferentially selected.

11. The system of claim 1, wherein the selection module selects, from the plurality of users, the one or more other users to be introduced such that users using the recommended game at a higher degree of use are preferentially selected.

12. The system of claim 1, wherein the selection module selects, from the plurality of electronic contents used by the one or more other users, the recommended electronic content such that an electronic content used by other users having higher closeness with the one user is preferentially selected.

13. The system of claim 1, wherein the selection module selects, from the plurality of electronic contents used by the one or more other users, the recommended electronic content such that an electronic content used by a larger number of other users is preferentially selected.

14. The system of claim 1, wherein the selection module selects, from the plurality of electronic contents used by the one or more other users, the recommended electronic content such that an electronic content used by other users at a higher degree of use is preferentially selected.

15. A system capable of providing a plurality of electronic contents to a plurality of users each operating a terminal device communicatively connected to the system, the system comprising:
an information storage means for storing at least closeness information specifying closeness between the plurality of users and use degree information specifying degree of use of each of the plurality of electronic contents by each of the plurality of users;
a selection means for selecting, from the plurality of electronic contents, a recommended electronic content to be recommended to one user and selecting, from the plurality of users, one or more other users to be introduced as users using the recommended electronic content based on the closeness information and the use degree information;
a screen setting means for setting screen data of a content recommendation screen including information specifying the recommended electronic content to be recommended to the one user, information specifying the one or more other users to be introduced, and a link to a user-related screen for making a friend request to the one or more other users to be introduced; and
a sending means for sending the screen data to the terminal device operated by the one user,
wherein the content recommendation screen includes information specifying one or more electronic contents used by the one user and is a screen for the one user to start using the one or more electronic contents, and
wherein the screen setting means sets screen data of the content recommendation screen including information specifying the one or more other users to be introduced and the link to the user-related screen with respect to the recommended electronic content to be recommended to the one user among the one or more electronic contents used by the one user.

16. A method of recommending electronic contents by using a system capable of providing a plurality of electronic contents to a plurality of users each operating a terminal device communicatively connected to the system, the method comprising the steps of:
(a) storing, on the system, at least closeness information specifying closeness between the plurality of users and use degree information specifying degree of use of each of the plurality of electronic contents by each of the plurality of users;
(b) selecting, from the plurality of electronic contents, a recommended electronic content to be recommended to one user and selecting, from the plurality of users, one or more other users to be introduced as users using the recommended electronic content based on the closeness information and the use degree information;
(c) setting screen data of a content recommendation screen including information specifying the recommended electronic content to be recommended to the one user, information specifying the one or more other users to be introduced, and a link to a user-related screen for making a friend request to the one or more other users to be introduced; and
(d) sending the screen data to the terminal device operated by the one user,
wherein the content recommendation screen includes information specifying one or more electronic contents used by the one user and is a screen for the one user to start using the one or more electronic contents, and
wherein the step (c) includes setting of screen data of the content recommendation screen including information specifying the one or more other users to be introduced and the link to the user-related screen with respect to the recommended electronic content to be recommended to the one user among the one or more electronic contents used by the one user.
